(19) United States
(12) Patent Application Publication
(10) Pub. No.: US 2014/0278546 A1
(43) Pub. Date: Sep. 18, 2014

(54) SYSTEM AND METHOD FOR POPULATION HEALTH MANAGEMENT CONSIDERING INDIVIDUAL PATIENT RISK AND RESOURCE CONSTRAINTS

(71) Applicant: KONINKLIJKE PHILIPS N.V., EINDHOVEN (NL)

(72) Inventors: Jorn OP DEN BUIJS, EINDHOVEN (NL); Steffen Clarence PAUWS, EINDHOVEN (NL)

(73) Assignee: KONINKLIJKE PHILIPS N.V., EINDHOVEN (NL)

(21) Appl. No.: 14/205,399

(22) Filed: Mar. 12, 2014

Related U.S. Application Data
(60) Provisional application No. 61/789,122, filed on Mar. 15, 2013.

(51) Int. Cl. G06F 19/00

(52) U.S. Cl. CPC G06F 19/322; G06F 19/3487
USPC 705/3

(57) ABSTRACT

A method for population health management includes retrieving patient data associated with one or more patient, retrieving one or more chronic disease management (CDM) programs applicable to each patient based on the patient data, retrieving a health effect and cost for each the applicable one or more CDM programs, recommending a CDM program with a largest health effect and within a budget for each patient, and displaying the recommended CDM program for the one or more patients.

The present application relates generally to population health management considering individual patient risk and resource constrains. It finds particular application in conjunction with recommending a chronic disease management program for each patient that will result in the largest health effect for an entire population under consideration and will be described with particular reference thereto. However, it is to be understood that it also finds application in other usage scenarios and is not necessarily limited to the aforementioned application.

In the United States it is expected that by 2030 almost one in five individuals will be 65 years or older. The rapid growth of the aging cohort is contributing to an increased prevalence of chronic diseases and greater use of healthcare resources. The US Centers for Disease Control and Prevention (CDC) reports that 7 out of 10 deaths among Americans each year are from chronic diseases, with heart disease, cancer and stroke accounting for more than 50% of all deaths. Chronic diseases account for an estimated 75% of healthcare costs. Health systems that maintain current disease management practices cannot afford to continue caring for the escalating numbers of people with chronic diseases.

Chronic disease management (CDM) is a systematic approach for coordinating health care interventions and communication at the individual, organizational, regional or national level. Coordinated approaches seem to be more effective than single or uncoordinated interventions, although the best strategies for integrating interventions across different providers, regions and funding systems remain uncertain. CDM programs organize care in multidisciplinary programs with many components, using a proactive approach that focuses on the whole course of a chronic disease. They incorporate the coordination of health care, pharmaceutical or social interventions designed to improve outcomes. It recognizes that a systematic approach is an optimal and cost-effective way of providing health care.

One of the reasons for healthcare costs continuing to soar is that an estimated $300 billion dollars are wasted annually due to inefficient allocation of healthcare resources. To overcome this problem, healthcare economics analyses (cost-effectiveness analyses) are more and more often used to evaluate the benefits and financial consequences of healthcare interventions, such as (elements of) CDM programs. The costs are compared with outcomes measured in natural units such as life years gained, or pain or symptom free days gained. For example, a system and method for healthcare economic analysis of pharmaceutical interventions has been previously described in US 2007/0179809 A1.

The analytic tools used in cost-effectiveness analysis may be extremely applicable in recommending (elements of) CDM programs to patients with chronic diseases. A wide variety of CDM programs may be available, aimed at reducing (re-)hospitalizations and/or mortality. Cost-effectiveness analysis may help medical professionals and policy makers to make an informed decision about the most cost-effective CDM program based on the latest medical evidence available.

Currently, the analytic tools for healthcare economic analyses are geared towards policy makers and take on a high level perspective (e.g., a societal perspective). A limitation of current tools is that they do not explicitly consider individual patient risks and budget constraints of a health care organization. Under the new PPACA, the so-called “Accountable Care Organizations” seek to provide the best care for a given amount of provider reimbursements. For these organizations, it seems imperative to combine individual patient risks and budget constraints in cost-effectiveness analysis to decide which healthcare services to provide to which patients, given resource constraints.

The present application is directed to a system and method to most effectively allocate healthcare resources, given individual patient risks and organizational budget constraints. The present application is intended for healthcare organizations providing health care to a patient population where a selection among a variety of CDM programs or program elements must be made for each individual patient. It should be noted that the present application may also apply to other type of healthcare services and interventions.

For example, if a care organization is constraint by a single total budget (lump sum for the whole population) and there is a distribution of costs across different programs, then there might be different subsets of programs across patients that fit within this budget by possibly trading-off some of the benefits of these programs differently. The present application addresses this issue by recommending the most effective care programs given the budget constraint.

The present application provides new and improved methods and systems which overcome the above-referenced problems and others.

In accordance with one aspect, a method for population health management is provided. The method includes retrieving patient data associated with one or more patient, retrieving one or more chronic disease management (CDM) programs applicable to each patient based on the patient data, retrieving a health effect and cost for each of the applicable one or more CDM programs, recommending a CDM program with a largest health effect and within a budget for each patient, and displaying the recommended CDM program for the one or more patients.

In accordance with another aspect, a system for population health management is provided. The system includes one or more processor programmed to retrieve patient data associated with one or more patient, retrieve one or more chronic disease management (CDM) programs applicable to each patient based on the patient data, retrieve a health effect and cost for each the applicable one or more CDM programs, recommend a CDM program with a largest health effect and within a budget for each patient, and display the recommended CDM program for the one or more patients.

In accordance with another aspect, a system for population health management is provided. The system includes a patient information system which stores patient data associated with one or more patient. A medical information system stores one or more chronic disease management (CDM) programs applicable to each patient based on the patient data. A clinical decision support system retrieves one or more CDM programs applicable to the one or more patients, retrieves a health effect and cost for each the applicable one or more CDM programs, and recommend a CDM program with a largest health effect and within a budget for each patient. A clinical interface system displays the recommended CDM program for the one or more patients.

One advantage resides in recommending a chronic disease management program for each patient that will result in the largest health effect for an entire population under consideration.

Another advantage resides in incorporating advanced prediction models for the prediction of future health outcomes and costs.

Another advantage resides in improving patient care.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

FIG. 1 illustrates a block diagram of an IT infrastructure according to aspects of the present application.

FIG. 2 illustrates an exemplary embodiment of a graph plotting costs vs. health effects for different CDM programs according to aspects of the present application.

FIG. 3 illustrates a flowchart diagram for achieving maximum health effect in patient population given budget constraints according to aspects of the present application.

FIG. 4 illustrates a flowchart diagram for labeling programs by their ICER according to aspects of the present application.

FIG. 5 illustrates a flowchart diagram for labeling patient-program combination as within budget based on ranking ICER according to aspects of the present application.

The present application is directed to a system and method for population health management considering individual patient risk and resource constraints. Specifically, the present application is directed to a system and method which inputs patient clinical data and costs parameters and outputs a recommendation of a chronic disease management (CDM) program for each patient, such that for the entire population under consideration the largest health effect is achieved. During this recommendation, the present application utilizes predictors of the health effects and costs for all patient-CDM program combinations. The present application also takes into account monetary constraints that are applicable to the organization providing the care for the patient population under consideration. Patient-CDM program combinations that are not cost-effective given other options (dominated programs) are removed prior to recommendation. It should be noted that the present application does not necessarily mean that patients at the highest risk will be “served first” with the most costly care. In contrast, the present application is directed to recommending a costly CDM program earlier to those patients who are expected to have the greatest benefit in a cost-effective way from that CDM program.

With reference to FIG. 1, a block diagram illustrates one embodiment of an IT infrastructure 10 of a medical institution, such as a hospital. The IT infrastructure 10 suitably includes a patient information system 12, a medical information system 14, a decision support system (DSS) 16, and a clinical interface system 18 and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the IT infrastructure be located at a central location or at multiple remote locations.

The patient information system 12 stores patient data related to one or more patients being treated by the medical institution. The patient data include physiological data collected from one or more sensors, laboratory data, imaging data acquired by one or more imaging devices, clinical decision outputs such as early warning scores, state of the patient, and the like. The patient data may also include the patient's medical records, the patient's administrative data (patient's name and location), the patient's medical records, the patient's clinical problem(s), the patient's demographics such as weight, age, family history, co-morbidities, body mass index, systolic/diastolic blood pressure and values of relevant blood markers (e.g., NT-proBNP for heart failure patients; glucose and/or HbAlc for diabetes patients; creatinine and/or urea for chronic kidney failure patients), and the like. In a preferred embodiment, the patient data includes name, medical indication, age, gender, body mass index, systolic/diastolic blood pressure, relevant blood markers, the results of medical questionnaires about the patient's health and quality of life, and the like. Further, the patient data can be gathered automatically and/or manually. As to the latter, user input devices 22 can be employed. In some embodiments, the patient information system 12 include display devices 24 providing users a user interface within which to manually enter the patient data and/or for displaying generated patient data. In one embodiment, the patient data is stored in the patient information database 26. Examples of patient information systems include, but are not limited to, electronic medical record systems, departmental systems, and the like.

Similarly, the medical information system 14 stores medical data related to CDM programs and/or program elements stored in a CDM program database 30. For example, the medical information system 14 stores CDM programs for chronic diseases such as heart failure, stroke, diabetes, chronic kidney failure, Alzheimer's disease and COPD. The medical data include one or more program elements corresponding to the CDM programs. In one embodiment, for each patient, a number of CDM programs may be applicable given the patient's diagnosis, co-morbidities, or patient state. Specifically, for each patient it is indicated which chronic disease management programs are applicable. This relation may be the result of a manual data entry and/or automated matching based on the patient diagnosis, co-morbidities, or patient state. Programs may consist of elements such as telemonitoring (weight, blood pressure, ECG, SpO2, glucose measurements), nurse telephone support, education, weight loss, dietary restrictions, exercise, various types of personal emergency systems, smoking cessation, and the like. Furthermore, “standard” or “usual” care may also be included as a program. Further, the medical data can be gathered automatically and/or manually. As to the latter, user input devices 32 can be employed. In some embodiments, the medical information systems 14 include display devices 34 providing users a user interface within which to manually enter the medical data and/or for displaying generated medical data. Examples of medical information systems include, but are not limited to, medical literature databases, medical trial and research databases, regional and national medical systems, and the like.

The DSS 16 stores clinical models and algorithms embodying the clinical support tools or patient decisions aids. The clinical models and algorithms are utilized by a recommendation engine 40 and a cost-health effectiveness engine 42 of the DSS 16 to generate one or more recommendations of a chronic disease management (CDM) program for each patient, such that for the entire population under consideration the largest health effect is achieved. Further, the clinical models and algorithms utilize predictors of the health effects and costs for all patient-CDM program combinations. Additionally, the clinical models and algorithms take into account monetary constraints that are applicable to the organization providing the care for the patient population under consideration. Specifically, the clinical models and algorithms include one or more risk prediction models. For each patient, the expected health effects are computed under the assumption that they would be enrolled into the applicable CDM programs. The clinical models and algorithms also include one or more cost prediction models. For each patient, the expected costs are computed under the assumption that they would be enrolled into the applicable CDM programs. As shown in Table 1 below, multiple health effects in terms of quality adjusted life years (QALY) and multiple costs values for multiple programs may be computed for an individual patient.

TABLE 1

| Patient | CDM program | Health effect | Cost |
|---|---|---|---|
| 1 | A | 2.1 QALY | $5,000 |
| 1 | B | 2.3 QALY | $6,000 |
| 1 | C | 2.0 QALY | $6,000 |
| 2 | A | 1.7 QALY | $9,000 |
| 2 | B | 1.7 QALY | $9,500 |
| 2 | C | 1.8 QALY | $9,100 |
| 3 | A | 3.2 QALY | $12,000 |
| 3 | B | 3.8 QALY | $8,000 |
| 3 | C | 3.9 QALY | $9,000 |

It should be appreciated that the predicted health effect may include survival rate, hospitalization rate, risk of a fall or incident, risk of ambulance transport to the emergency department, quality of life, quality of life adjusted survival, or a combination thereof. It should also be appreciated that the predicted costs may include disease management program costs, ambulance service costs, emergency department costs, hospitalization costs, medication costs, general practitioner costs, costs related to workflow (e.g., physician/nurse time) or a combination thereof. In the preferred embodiment, the DSS 16 adjusts the costs for expected survival. The DSS 16 also calculates the prediction of effects and costs over a user-specified time-period. In another embodiment, predicted effects and costs may be “discounted” using region-specific percentages, to account for the fact that future costs and effects are weighted less than current costs and effects. The risk and cost prediction models are in the form of linear models, logistic regression models, classification/regression trees, Cox proportional hazards models, support vector machines, neural networks, and/or ensemble learners (random forest, gradient boosting etc.). Other applicable prediction models will be known to those skilled in the art.

The DSS 16 utilizes the clinical models and algorithms to generate one or more recommendations of a chronic disease management (CDM) program for each patient, such that for the entire population under consideration the largest health effect is achieved. Specifically, the DSS 16 utilizes a cost-health effectiveness engine 42 to calculate a minimal cost to provide an intervention to all patients in the patient population of interest (i.e., the sum over all patients of the most inexpensive intervention) and calculate a cost required to achieve maximal health effects for the patient population under consideration (i.e., the sum over all patients of the cost of the intervention with the largest health effect). The recommendation engine 40 recommends a CDM program for each patient, such that the expected total costs are equal to, or just below, the budget, while the expected health effects are maximized given the budget.

Specifically, the DSS 16 generates a user interface which enables the user select a list of patients (population) for whom a program recommendation is desired. The selection may be based on diagnosis, age, co-morbidities, hospital admission/discharge date and the like; select cost and risk prediction models and, if applicable, input model parameters; input budget constraint(s) for the patient population of interest; examine the recommended CDM programs on the patient level; visualize the expected population health effects based on the current budget; and calculate and compare various what-if scenarios (e.g., different budgets). In the preferred embodiment, the budget is a lump sum constraint for the entire population under consideration. It is a value representing an upper limit using some monetary unit. The assumption is that the budget covers at least all least costly programs.

The DSS 16 utilizes the above-mentioned user inputs and clinical models and algorithms to provide a recommendation of the CDM program for each patient. Specifically, the cost-health effectiveness engine 42 retrieves one or more CDM programs applicable to a patient along with the health effects and costs for those CDM programs. The cost-health effectiveness engine 42 then sorts the one or more CDM programs in ascending order according to the cost of the programs. The cost-health effectiveness engine 42 removes the dominate CDM programs and computes an incremental cost-effectiveness ratio for the remaining CDM programs. To achieve maximum health effects under the budget constraints, it is impertinent that per patient, the “dominated” programs are removed from consideration (they are labelled as “dominated”). These are program that are not cost-effective given their alternatives. The cost-health effectiveness engine 42 also calculates the incremental cost-effectiveness ratio (ICER) for the patient-program combination. A hypothetical example of the concept of dominance is plotted in FIG. 2. The hypothetical graph includes a plot of the costs vs. health effects for six different CDM programs. This graph applies to one particular patient. The minimal cost program is denoted by P₀. The other cost-effective programs P₁₋₃ are ranked by increasing ICERs. Two programs within the ‘convex hull’ are labelled as dominated and not considered further in the method, as they are not cost-effective. This process is then completed for all patients within the patient population. The recommendation engine 40 sorts the CDM programs by the ICER and determines which patient-program combinations are within budget. Further, the recommendation engine 40 ranks the patient-program combinations by ICER and selects a limited set of patient-program combinations with the lowest ICERs such that the total costs are within the budget. For each patient, the recommendation engine 40 also generates a list of CDM programs with the largest health effect that are within budget. The recommendation engine 40 then recommends the CDM program with the largest health benefit within budget for the patient.

The clinical interface system 18 enables the user to select a list of patients (population) for whom a program recommendation is desired. The selection may be based on diagnosis, age, co-morbidities, hospital admission/discharge date and the like; select cost and risk prediction models and, if applicable, input model parameters; input budget constraint(s) for the patient population of interest; examine the recommended CDM programs on the patient level; visualize the expected population health effects based on the current budget; and calculate and compare various what-if scenarios (e.g., different budgets). In the preferred embodiment, the budget is a lump sum constraint for the entire population under consideration. In one embodiment, the clinical interface system 18 enables the user to enter specific settings for the cost-effectiveness analysis. The clinical interface system 18 also receives a quantitative evaluation and comparison of the alternative choices of CDM programs. For example, the clinical interface system 18 displays the list of CDM programs with the largest health effect that are within budget and the recommended CDM programs with the largest health benefit within budget for the patient. The clinical interface system 18 includes a display 42 such as a CRT display, a liquid crystal display, a light emitting diode display, to display the evaluation and/or comparison of choices and a user input device 44 such as a keyboard and a mouse, for the user to input the patient values and preferences and/or modify the evaluation and/or comparison. Examples of clinical interface systems 18 include, but are not limited to, a software application that could be accessed and/or displayed on a personal computer, web-based applications, tablets, mobile devices, cellular phones, and the like.

The exemplary patient-program combinations from Table 1 above are shown after processing in Table 2 below. In this table, the incremental cost-effectiveness ratio is given (unless it is the least costly program) and if the ICER is <0, then the program is labelled as dominated. For each patient-program combination, the incremental cost is computed. After sorting by ICER (not shown in the Table), the incremental costs are added to the total minimal costs until the budget is exceeded.

TABLE 2

| Pa- | Pro- | Health | | | Domi- | Incremental |
|---|---|---|---|---|---|---|
| tient | gram | effect | Cost | ICER | nated | cost ΔC |
| 1 | A | 2.1 QALY | $5,000 | — | No | 0 |
| 1 | B | 2.3 QALY | $6,000 | 5,000 | No | 1,000 |
| 1 | C | 2.0 QALY | $6,000 | <0 | Yes | — |
| 2 | A | 1.7 QALY | $9,000 | — | No | 0 |
| 2 | B | 1.7 QALY | $9,500 | <0 | Yes | — |
| 2 | C | 1.8 QALY | $9,100 | 1,000 | No | 100 |
| 3 | A | 3.2 QALY | $12,000 | <0 | Yes | — |
| 3 | B | 3.8 QALY | $8,000 | — | No | 0 |
| 3 | C | 3.9 QALY | $9,000 | 10,000 | No | 1,000 |

The minimal, maximal costs and the budget for the exemplary patient-program combinations from Table 1 above are shown in Table 3 below. For Table 1, the dominated programs are removed and the remaining patient-program combinations are sorted by ICER (ascending), to determine if the program is within the budget (is the cumulative cost within the budget). It is assumed that the budget is larger than the total cost for the least costly programs.

TABLE 3

| | | | | | Incre- | Cumu- | |
|---|---|---|---|---|---|---|---|
| Pa- | Pro- | Health | | | mental | lative | Within |
| tient | gram | effect | Cost | ICER | cost ΔC | cost | budget |
| 1 | A | 2.1 QALY | $5,000 | — | 0 | | Least |
| | | | | | | | costly |
| | | | | | | | program |
| 2 | A | 1.7 QALY | $9,000 | — | 0 | | Least |
| | | | | | | | costly |
| | | | | | | | program |
| 3 | B | 3.8 QALY | $8,000 | — | 0 | $22,000 | Least |
| | | | | | | | costly |
| | | | | | | | program |
| 2 | C | 1.8 QALY | $9,100 | 1,000 | 100 | $22,100 | Yes |
| 1 | B | 2.3 QALY | $6,000 | 5,000 | 1,000 | $23,100 | Yes |
| 3 | C | 3.9 QALY | $9,000 | 10,000 | 1,000 | $24,100 | No |

The cost and effects pertaining to the various CDM programs and recommended CDM programs for the exemplary patient-program combinations from Table 1 are shown in Tables 4 and 5 respectively below.

TABLE 4

| Scenario | Cost | Effects |
|---|---|---|
| Minimal cost option | $22,000 | 7.6 QALY |
| Maximum effect option | $24,100 | 8.0 QALY |
| Budget | $23,100 | 7.9 QALY |

TABLE 5

| Patient | Recommendation |
|---|---|
| 1 | B |
| 2 | C |
| 3 | B (C not within budget) |

In a preferred embodiment, individual patient case management is possible. For every individual patient, the DSS 16 tracks the recommended CDM program, the actually chosen CDM program, the reason for (not) choosing the recommended CDM program, the predicted and the actual health effects associated with the chosen CDM program, and the predicted and the actual costs associated with the chosen CDM program. In another embodiment, an overview of actual and predicted population health effects and costs can be displayed. In another embodiment, an audit trail is implemented to keep track of clinical/administrative user logins and other actions. In yet another embodiment, a user might pre-select those patients who are to be considered for programs. In this case, the total costs for those patients are subtracted from the lump sum budget, and the pre-selected patients are left out of the current algorithm.

The components of the IT infrastructure 10 suitably include processors 46 executing computer executable instructions embodying the foregoing functionality, where the computer executable instructions are stored on memories 48 associated with the processors 46. It is, however, contemplated that at least some of the foregoing functionality can be implemented in hardware without the use of processors. For example, analog circuitry can be employed. Further, the components of the IT infrastructure 10 include communication units 50 providing the processors 46 an interface from which to communicate over the communications network 20. Even more, although the foregoing components of the IT infrastructure 10 were discretely described, it is to be appreciated that the components can be combined.

With reference to FIG. 3, a flowchart diagram 100 for achieving maximum health effect in patient population given budget constraints is illustrated. The method 100 is executable by one or more processors and the like as illustrated in FIG. 1. In a step 102, a database stored data associated with patients, applicable CDM programs, expected costs of the CDM programs, and expected health effects of the CDM programs. In a step 104, a first patient is selected. In a step 106, the health effects and costs for all programs applicable to the patient are retrieved. In a step 108, the CDM programs are sorted on cost in ascending order. In a step 110, the dominated CDM programs are removed and the ICER for the remaining programs are calculated. In a step 112, it is determined if this process has been completed for all patients. If this process has not been completed for all patients, the next patient is processed in a step 114. If all of the patients have been processed, the CDM programs are sorted by ICER and it is determined which patient-program combinations are within budget in a step 116. In a step 118, for each patient, the program with the largest health effect within the budget is selected. In a step 120, the selected CDM programs is recommended for the patient.

With reference to FIG. 4, a flowchart diagram 200 for labeling programs by their ICER is illustrated. The method 200 is executable by one or more processors and the like as illustrated in FIG. 1. In a step 202, the CDM program with the lowest cost is selected. In a step 204, in case of ties, the CDM program with the greatest health effect is selected. In a step 206, the selected program is labeled as Pᵢ. In a step 208, the selected program is label Pᵢ₊₁. In a step 210, for each of the remaining unlabeled programmed, the cost difference, health effect difference, and cost-effectiveness ratio (ICER) is calculated. Specifically, to compute the cost difference for each program, the cost of each program is subtracted from the cost of selected program Pᵢ. Similarly, to calculate the health effect difference, the health effect of each program is subtracted from the health effect of selected program Pᵢ. To calculate the ICER, the cost difference for each program is divided by the health effect difference for each program. In a step 212, programs for which the cost-effectiveness ratio is less than 0 are labeled as dominated. In a step 214, the program with the smallest cost-effectiveness ratio (ICER) is selected. In a step 216, the ICER is stored. The process is repeated in a step 206, until all of the CDM programs have been completed.

With reference to FIG. 5, a flowchart diagram 300 for labeling patient-program combination as within budget based on ranking ICER is illustrated. The method 300 is executable by one or more processors and the like as illustrated in FIG. 1. In a step 302, the total cost of patient-program combination where a CDM programs is labeled as P₀ is calculated. In a step 304, the minimal cost of the CDM program is output. In a step 306, the patient-program combinations where programs is not P₀ are sorted by ICER in ascending order. In a step 308, the cost difference of patient-program combination with the next lowest ICER is retrieved. In a step 310, this cost difference is added to the total cost. In a step 312, it is determined if the total cost is within the budget. If the total cost is not within budget, end the process in a step 314. If the total cost is within budget, label the patient-program combination as within budget in a step 316. The process is then repeated in a step 308, until all CDM programs within budget have been labeled.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor or engine includes one or more of a microprocessor, a microcontroller, a graphic processing unit (GPU), an application-specific integrated circuit (ASIC), a field-programmable gate array (FPGA), personal data assistant (PDA), cellular smartphones, mobile watches, computing glass, and similar body worn, implanted or carried mobile gear; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

Having thus described the preferred embodiments, the invention is now claimed to be:

1. A method for population health management, the method comprising:
retrieving patient data associated with one or more patient;
retrieving one or more chronic disease management (CDM) programs applicable to each patient based on the patient data;
retrieving a health effect and cost for each the applicable one or more CDM programs;
recommending a CDM program with a largest health effect and within a budget for each patient; and
displaying the recommended CDM program for the one or more patients.

2. The method according to claim 1, further including:
computing a cost-effectiveness ratio for each of the one or more CDM programs.

3. The method according to claim 1, wherein the cost-effectiveness ratio is calculated by comparing a cost difference and a health effect difference between each of the one or more CDM programs.

4. The method according to claim 1, further including:
labeling CDM programs with a cost-effectiveness ratio greater than zero as dominant; and
removing the dominant CDM programs from being recommended.

5. The method according to claim 1, wherein the step of recommending includes:
sorting the one or more CDM programs by their cost-effectiveness ratio; and
determining which combination of the one or more CDM programs are within budget.

6. The method according to claim 1, wherein the health effect includes at least one of survival rate, hospitalization rate, risk of a fall or incident, risk of ambulance transport to the emergency department, quality of life, quality of life adjusted survival, or a combination thereof; and
wherein cost includes at least one of disease management program costs, ambulance service costs, emergency department costs, hospitalization costs, medication costs, general practitioner costs, costs related to workflow or a combination thereof.

7. A system for population health management, the system comprising:
one or more processor programmed to:
retrieve patient data associated with one or more patient;
retrieve one or more chronic disease management (CDM) programs applicable to each patient based on the patient data;
retrieve a health effect and cost for each the applicable one or more CDM programs;
recommend a CDM program with a largest health effect and within a budget for each patient; and
display the recommended CDM program for the one or more patients.

8. The system according to claim 7, wherein the one or more processor are further programmed to:
compute a cost-effectiveness ratio for each of the one or more CDM programs.

9. The system according to claim 7, wherein the cost-effectiveness ratio is calculated by comparing a cost difference and a health effect difference between each of the one or more CDM programs.

10. The system according to claim 7, wherein the step of recommending further includes:
sorting the one or more CDM programs by their cost-effectiveness ratio; and
determining which combination of the one or more CDM programs are within budget.

11. The system according to claim 7, wherein the one or more processor are programmed to:
label CDM programs with a cost-effectiveness ratio greater than zero as dominant; and
remove the dominant CDM programs from being recommended.

12. A system for population health management, the system comprising:
a patient information system which stores patient data associated with one or more patient;
a medical information system which stores one or more chronic disease management (CDM) programs applicable to each patient based on the patient data;
a clinical decision support system which retrieves one or more CDM programs applicable to the one or more patients, retrieves a health effect and cost for each the applicable one or more CDM programs, and recommend a CDM program with a largest health effect and within a budget for each patient; and
a clinical interface system which displays the recommended CDM program for the one or more patients.

13. The system according to claim 12, wherein the clinical decision support system computes a cost-effectiveness ratio for each of the one or more CDM programs.

14. The system according to claim 12, wherein the clinical decision support system calculates a cost-effectiveness ratio by comparing a cost difference and a health effect difference between each of the one or more CDM programs.

15. The system according to claim 12, wherein the clinical decision support system sorts the one or more CDM programs by their cost-effectiveness ratio and determines which combination of the one or more CDM programs are within budget.

16. The method according to claim 2, wherein the cost-effectiveness ratio is calculated by comparing a cost difference and a health effect difference between each of the one or more CDM programs.

17. The method according to claim 2, further including:
labeling CDM programs with a cost-effectiveness ratio greater than zero as dominant; and
removing the dominant CDM programs from being recommended.

18. The method according to claim 3, further including:
labeling CDM programs with a cost-effectiveness ratio greater than zero as dominant; and
removing the dominant CDM programs from being recommended.

19. The method according to claim 2, wherein the step of recommending includes:
sorting the one or more CDM programs by their cost-effectiveness ratio; and
determining which combination of the one or more CDM programs are within budget.

20. The method according to claim 3, wherein the step of recommending includes:
sorting the one or more CDM programs by their cost-effectiveness ratio; and
determining which combination of the one or more CDM programs are within budget.
